(19) United States
(12) Patent Application Publication
(10) Pub. No.: US 2010/0246185 A1
(43) Pub. Date: Sep. 30, 2010

(54) LIGHT COLLECTION SYSTEM FOR A LUMINAIRE

(75) Inventor: Pavel JURIK, Postredni Becva (CZ)

Correspondence Address: HEINZ GRETHER PC;G2 Technology Law, P.O. Box 202858, AUSTIN, TX, 78720, US

(73) Assignee: ROBE LIGHTING S.R.O.

(21) Appl. No.: 12/749,655

(22) Filed: Mar. 30, 2010

Related U.S. Application Data
(60) Provisional application No. 61/165,268, filed on Mar. 31, 2009.

(51) Int. Cl. F21V 7/07; F21V 7/00; F21V 17/02

(52) U.S. Cl. 362/282; 362/296.01; 362/296.05

(57) ABSTRACT

Described are improved automated luminaire 12 and luminaire systems 10 employing remotely actuatable positioning of a reflector 106 relative to a lamp 102 mounted in the reflector 106 to change the relative position of the source 104 in the lamp 102 relative to the focal point 105 of the reflector 106 thus remotely adjusting the flatness of the intensity of the light beam generated by the luminaire 12.

RELATED APPLICATION(S)

This application is a utility filing claiming priority of provisional application 61/165,268 filed on Mar. 31, 2010.

### TECHNICAL FIELD OF THE INVENTION

The present invention generally relates to a method for controlling the light output from a lamp and reflector when used in a light beam producing luminaire, specifically to a method relating to improving control of the beam intensity profile.

### BACKGROUND OF THE INVENTION

Luminaires with automated and remotely controllable functionality are well known in the entertainment and architectural lighting markets. Such products are commonly used in theatres, television studios, concerts, theme parks, night-clubs and other venues. A product will typically provide control over the pan and tilt functions of the luminaire allowing the operator to control the direction the luminaire is pointing and thus the position of the light beam on the stage or in the studio. Typically this position control is done via control of the luminaire's position in two orthogonal rotational axes usually referred to as pan and tilt. Many products provide control over other parameters such as the intensity, color, focus, beam size, beam shape and beam pattern. The beam pattern is typically provided by a stencil or slide called a gobo which may be a steel, aluminum or etched glass pattern. The products manufactured by Robe Show Lighting such as the ColorSpot 1200E are typical of the art.

The optical systems of such luminaires may include a gate or aperture through which the light is constrained to pass. Mounted in or near this gate may be devices such as gobos, patterns, irises, color filters or other beam modifying devices as known in the art. The use of a variable aperture or iris allows control over the size of the output beam and thus the size of the image projected onto a surface.

FIG. 1 illustrates a multiparameter automated luminaire system 10. These systems commonly include a plurality of multiparameter automated luminaires 12 which typically each contain on-board a light source (not shown), light modulation devices, electric motors coupled to mechanical drives systems and control electronics (not shown). In addition to being connected to mains power either directly or through a power distribution system (not shown), each luminaire is connected is series or in parallel to data link 14 to one or more control desks 15. The luminaire system 10 is typically controlled by an operator through the control desk 15.

FIG. 2 illustrates a prior art automated luminaire 12. A lamp 21 contains a light source 22 which emits light. The light is reflected and controlled by reflector 20 through an aperture or imaging gate 24 and then through a variable aperture 23. The resultant light beam may be further constrained, shaped, colored and filtered by optical devices 26 which may include dichroic color filters, gobos, rotating gobos, framing shutters, effects glass and other optical devices well known in the art. The final output beam may be transmitted through output lenses 28 and 29 which may form a zoom lens system.

The light collection systems in such automated luminaires often use an ellipsoidal reflector. An ellipsoidal reflector has the property that light emitted from a source at the first of the two focal points of the ellipsoid will be directed through the second focal point. By siting the aperture near to the second focal point a maximum amount of light may be collected for use. To accurately position the light source at the first focal point requires means for adjusting the position of the lamp relative to the reflector. Typically this is done with adjustment screws by the user when a lamp is fitted. The user will optimize the position of the lamp both to get it onto the optical axis and to position it at the first focal point of the ellipsoidal reflector along the optical axis. Changing the position of the lamp along the optical axis will alter the distribution of the output light beam. Once the lamp is positioned then it is usually not moved until the lamp is changed again.

FIG. 3 illustrates a prior art system 100 where the emission point 104 of a light source 102 is positioned at or close to the first focal point 105 of an ellipsoidal reflector 106 such that the light 108 from light source 102 is reflected by the reflector 106 towards the second focal point 110 of the reflector 106. Aperture 112 is positioned close to the second focal point 110 of reflector 106 and a substantial proportion of the light 108 from light source 102 will pass through this aperture 112 and into downstream optics (not shown).

It would be advantageous if the position of the lamp could be controlled remotely such that the user can dynamically control the output distribution of the lamp and reflector collection system.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates a typical automated lighting system with multiple luminaires;

FIG. 2 illustrates typical optical components in a typical automated luminaire

FIG. 3 illustrates a prior art light collection beam generation system;

FIG. 4 illustrates an embodiment of a remotely actuated reflector showing the reflector in its central, normal, position;

FIG. 5 illustrates an embodiment of the actuated reflector of FIG. 4 showing the reflector in its forward position;

FIG. 6 illustrates an embodiment of the actuated reflector of FIG. 4 showing the reflector in its rearward position;

FIG. 7 illustrates the optical system of an embodiment of the invention with the light source at the first focal point;

FIG. 8 illustrates the optical system of an embodiment of the invention with the light source further back than the first focal point;

FIG. 9 illustrates the optical system of an embodiment of the invention with the light source further forward than the first focal point;

FIG. 10 illustrates an embodiment of the invention where the lamp position is remotely actuated;

FIG. 11 illustrates an embodiment of the invention showing the reflector in its central, normal, position and the iris in a first position;

FIG. 12 illustrates an embodiment of the invention showing the reflector in its forward position and the iris in a second position; and

FIG. 13 illustrates an embodiment of the invention showing the reflector in its rearward position and the iris in a third position.

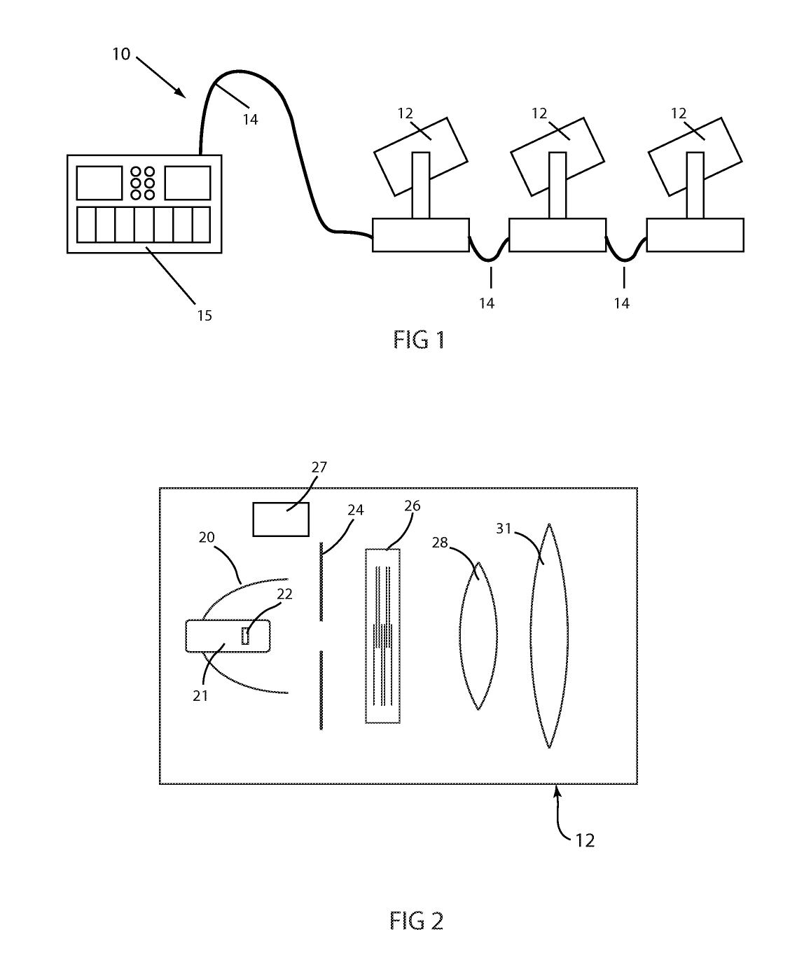

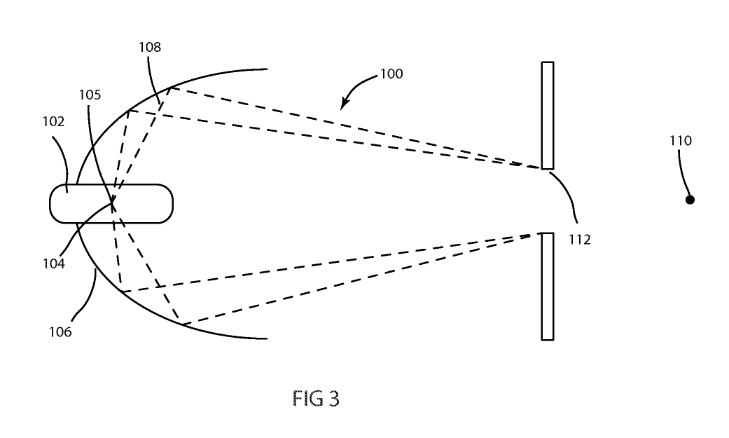

### DETAILED DESCRIPTION OF THE INVENTION

Preferred embodiments of the present invention are illustrated in the FIGUREs, like numerals being used to refer to like and corresponding parts of the various drawings.

The present invention generally relates to a method for controlling the light output from a lamp and reflector when used in a light beam producing luminaire, specifically to a method relating to improving control of the beam profile and beam homogenization.

FIG. 4 illustrates a further embodiment of the invention where ellipsoidal reflector 106 is mounted such that motors 130 and 132 may move the reflector along the optical axis. Other shaped reflectors are contemplated for other embodiments. In FIG. 4 the reflector's 106 position relative to the light source 102 is shown in its nominal position where the emission point 104 of light source 102 is positioned at the first focal point 105 of the ellipsoidal reflector 106 and light is directed through aperture 112 with its normal slightly peaky light beam 200 distribution as further described below.

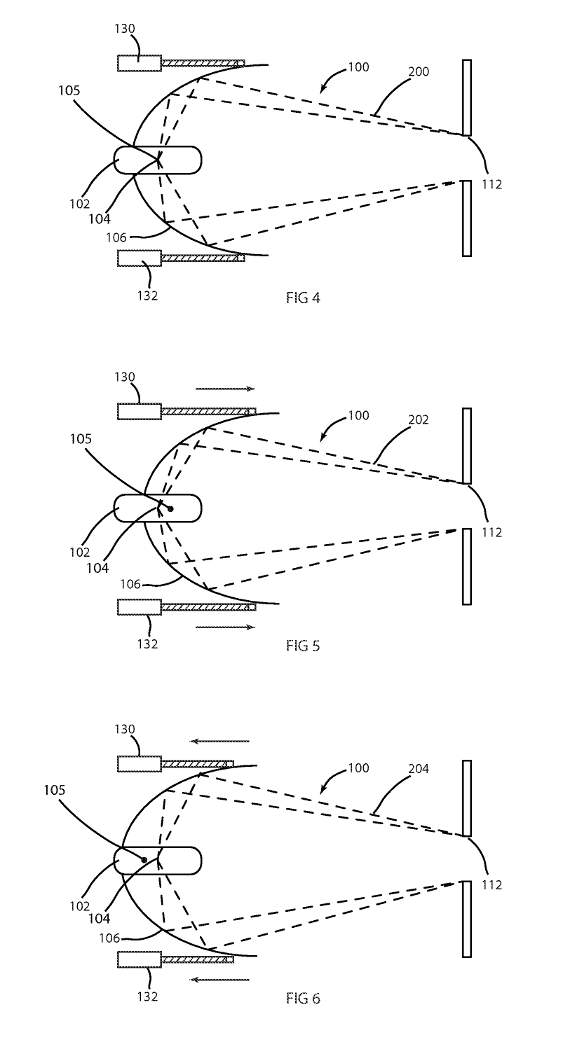

If motors 130 and 132 are activated in a first direction then reflector 106 may be moved forwards as illustrated in FIG. 5. In this second-forward position the emission point 104 of light source 102 is positioned behind the first focal point 105 of ellipsoidal reflector 106 and light is directed through aperture 112 with a peakier distribution and increased hot spot light beam 202 distribution as further described below.

If motors 130 and 132 are activated in the reverse direction then reflector 106 may be moved rearwards as illustrated in FIG. 6. In this third rearward position the emission point 104 of light source 102 is positioned in front of the first focal point 105 of ellipsoidal reflector 106 and light is directed through aperture 112 with a flatter distribution and reduced hot spot light beam 204 distribution as further described below.

Although two motors 130 and 132 have been herein illustrated the invention is not so limited and any number of motors may be used to control the position of the ellipsoidal reflector. The motors may be of a type selected from a list comprising but not limited to, stepper motors, servo motors, linear actuators. The movement of the reflector in the preferred embodiment is continuous providing multiple positions between and extreme forward and extreme back position. In other embodiments the movement may be more stepwise with two or more positions selectable by the user through the automated lighting system in which the luminaire is a part.

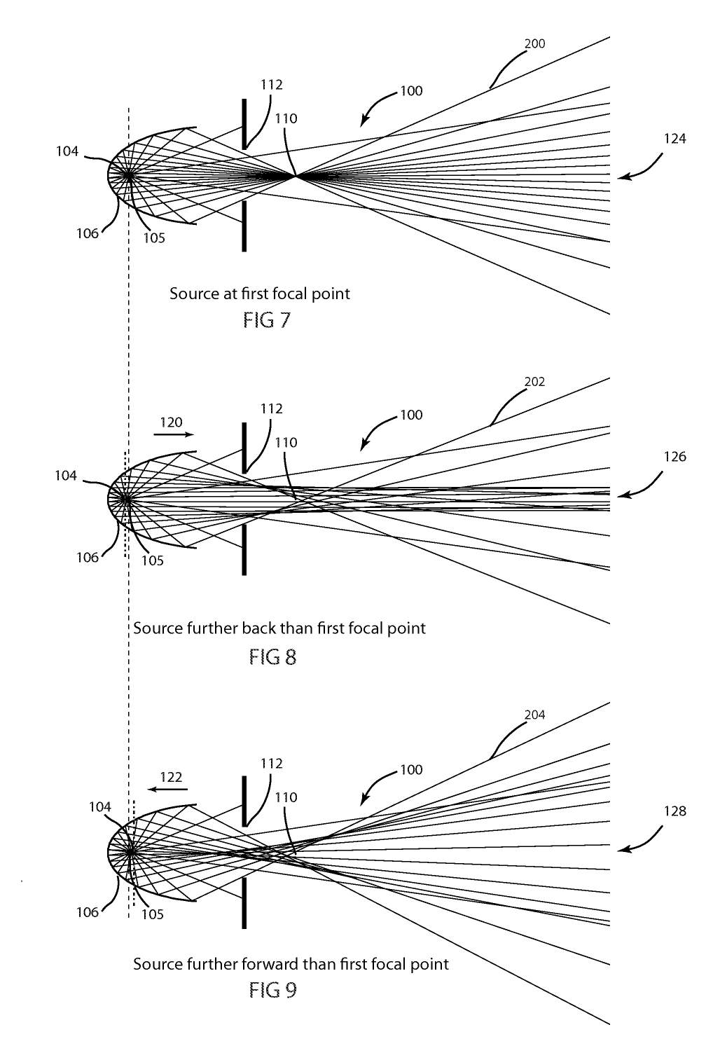

FIG. 7 illustrates a ray trace of an embodiment of a light collection system 100 of the invention where a light source 104 (for clarity illustrated here as an idealized point source) is positioned at the first focal point 105 of an ellipsoidal reflector 106 as in FIG. 4 & FIG. 11. The light is collected by reflector 106 and directed through aperture 112 towards the second focal point 110. The collected light then continues towards further downstream optical systems (not shown) or towards the light target. The emergent light beam may be directed through a series of optical devices as well known within automated lights. Such devices may include but not be restricted to rotating gobo wheel containing multiple patterns or gobos, static gobo wheel containing multiple patterns or gobos, iris, color mixing systems utilizing subtractive color mixing flags, color wheels, framing shutters, frost and diffusion filters and, beam shapers. The final light beam may then pass through an objective lens system and which may provide variable beam angle or zoom functionality as well as the ability to focus on various components of the optical system before emerging as the required light beam.

The output beam 200 of light has a distribution 124. With the light source and reflector in this normal, prior art, configuration the output light distribution 124 is produced with more light in the center than around the edges such that the light fades out gradually as we move out from the center of the beam. The shape of this light distribution is typically in a bell curve shape and is commonly referred to as having a ‘hot spot’. The user may control the intensity of this hot spot and thus the flatness of the field by moving the light source backwards and forwards along the optical axis to one side of the first focal point 105 or the other during lamp installation. One improvement offered by this invention is to provide remote control of that relationship such the field flatness becomes a dynamic operational control that the lighting designer may use during a performance to adjust the beam to his desired profile at any moment. In one embodiment of the invention the position of the light source is fixed however the ellipsoidal reflector may be moved backwards and forwards relative to that light source along its optical axis.

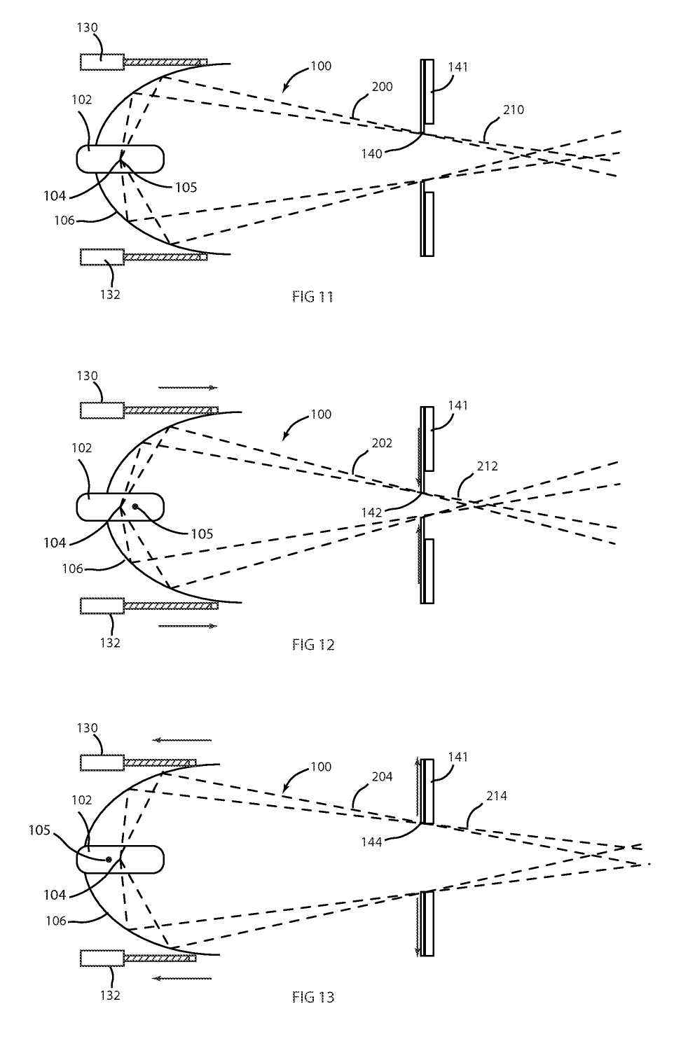

FIG. 8 illustrates a ray trace of an embodiment of the light collection system 100 of the invention illustrated in FIG. 7 where ellipsoidal reflector 106 has been moved forward along the optical axis as shown by arrow 120 such that light source 104 is positioned further back than the first focal point 105 of the ellipsoidal reflector 106 as in FIG. 5 and FIG. 12. Light beams will still pass through aperture 112 however they are not now directed through second focal point 110. Instead they are directed generally towards a point further along the optical axis. With this arrangement the distribution 126 of the output beam 202 becomes less flat and the central hotspot becomes more pronounced. Such a beam distribution may be advantageous for producing aerial beam effects.

Conversely FIG. 9 illustrates a ray trace of an embodiment of the light collection system 100 of the invention illustrated in FIG. 7 where ellipsoidal reflector 106 has been moved rearward along the optical axis as shown by arrow 122 such that light source 104 is positioned further forward than the first focal point 105 of the ellipsoidal reflector 106 as in FIG. 6 and FIG. 13. Light beams will still pass through aperture 112 however they are not now directed through second focal point 110. Instead they are directed generally towards a point closer along the optical axis. With this arrangement the distribution 128 of the output beam 204 becomes flatter and the central hotspot becomes less pronounced. Such a flat beam, although reduced in output from the position shown in FIG. 7, may be advantageous for projecting gobos where a flat field may be desirable.

Thus it can be seen that allowing the user to remotely control the relative positions of the ellipsoidal reflector and light source along the optical axis confers operational advantages over and above the prior art lamp alignment commonly performed only during a lamp change.

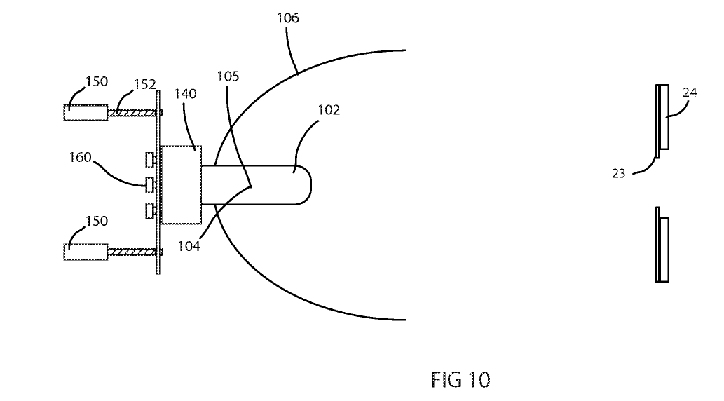

FIG. 10 illustrates an embodiment where the lamp 102 position is remotely actuatable by motor(s) 150 and couplings 152 which move the lamp 102 socket 140 relative to the reflector 106. This figure also illustrates the manual lamp adjustment screws 160 which can be used to manually adjust the position of the lamp 102 and its emission point 104 relative to the socket during a lamp change. The figure also illustrates a fixed aperture 24 and a variable aperture or iris 23.

FIGS. 11, 12 and 13 illustrate a yet further embodiment of the invention where the position of the reflector may be optimized in conjunction with the opening and closing of a variable aperture or iris so as to provide maximal light output through the iris. In FIG. 11 the system is shown in its nominal position where the light source 102 is positioned with its emission point 104 at the first focal point 105 of the ellipsoidal reflector 106 and light is directed through iris 140 with its normal slightly peaky distribution.

In FIG. 12 the iris has been stopped down to a smaller size 142. If the light source and reflector orientation were left unchanged then a large amount of the light would impact on the iris and not pass through the smaller central aperture 142. If, however, motors 130 and 132 are activated in a first direction such that reflector 106 is moved forwards so that the emission point 104 of light source 102 is positioned behind the first focal point 105 of ellipsoidal reflector 106 then light will be directed in a narrower, hot spot, beam with more light concentrated in the center of the beam such that a maximal amount of light will now pass through iris 142.

In FIG. 13 the iris has been opened up to a larger size 144. If the light source and reflector orientation were left unchanged then the outside edge of the aperture would be illuminated at a very low level. If, however, motors 130 and 132 are activated in a second direction such that reflector 106 is moved rearwards so that the emission point 104 of light source 102 is positioned in front of the first focal point 105 of ellipsoidal reflector 106 then light will be directed in a wider, flatter, beam with light distributed across the whole iris such that a maximal amount of light will now pass through iris 144.

In a yet further embodiment the movement of motors 130 and 132 may be coupled to that of the iris such that, as the iris is opened and closed and the aperture size changes the reflector position will be adjusted so as to optimally position the reflector relative to the light source so that the maximal light output is directed through the aperture in the iris. For example, as the user closes the iris aperture down motors 130 and 132 will simultaneously move the reflector forwards so as to direct more light through the smaller aperture. Conversely as the user opens the iris aperture up motors 130 and 132 will simultaneously move the reflector rearwards so as to optimally fill the larger aperture.

The coupling of the movement of the iris and the reflector may be any kind of coupling understood in the art. For example this could be a mechanical coupling where a single motor or motors drives the movement of the iris and the movement of the reflector through linkages or gearing. Alternatively there could be separate motors for the iris and the reflector and the coupling is electrical where both motors or sets of motors are fed with the same electrical signal. A yet further alternative is to couple the systems via firmware or software where the motors controlling the iris and the reflector are all controlled independently from a software based motor control system and the coupling occurs within said motor control system.

While the invention has been described with respect to a limited number of embodiments, those skilled in the art, having benefit of this disclosure, will appreciate that other embodiments may be devised which do not depart from the scope of the disclosure as disclosed herein. The invention has been described in detail, it should be understood that various changes, substitutions and alterations can be made hereto without departing from the spirit and scope of the disclosure.

What is claimed is:

1. An automated luminaire comprising
a light source;
a remotely actuated reflector which adjusts the position of the reflector relative to the light source from a remote location;
an iris for providing a remotely actuated variable aperture which gates the light beam generated by the luminaire.

2. The automated luminaire of claim 1 wherein:
the reflector is ellipsoidal in shape.

3. The automated luminaire of claim 1 wherein:
the electric motors actuate the adjustments to position of the reflector.

4. The automated luminaire of claim 3 wherein:
electric motors are stepper motors

5. The automated luminaire of claim 1 wherein:
the positions to which the reflector can be positioned are continuous along a range.

6. The automated luminaire of claim 1 wherein:
the positions to which the reflector can be positioned are a limited number of discrete positions

7. The automated luminaire of claim 1 wherein:
the adjustments to the position of the reflector can be used to remotely adjust the relative intensity flatness of the light beam generated by the luminaire.

8. The automated luminaire of claim 1 wherein:
the actuation of the reflector and iris is coupled.

9. The automated luminaire of claim 8 wherein:
the coupling is mechanical.

10. The automated luminaire of claim 1 wherein:
the coupling is electrical

11. The automated luminaire of claim 1 wherein:
the actuation of the reflector and iris can be controlled independently or codependently.

12. An automated luminaire comprising
a light source;
a remotely actuated reflector which adjusts the position of the reflector relative to the light source from a remote location.

13. The automated luminaire of claim 12 wherein:
the reflector is ellipsoidal in shape.

14. The automated luminaire of claim 12 wherein:
the electric motors actuate the adjustments to position of the reflector.

15. The automated luminaire of claim 14 wherein:
electric motors are stepper motors

16. The automated luminaire of claim 12 wherein:
the positions to which the reflector can be positioned are continuous along a range.

17. The automated luminaire of claim 12 wherein:
the positions to which the reflector can be positioned are a limited number of discrete positions

18. The automated luminaire of claim 12 wherein:
the adjustments to the position of the reflector can be used to remotely adjust the relative intensity flatness of the light beam generated by the luminaire.

19. The automated luminaire of claim 1 wherein:
the position of the light source relative to the reflector can also be mechanically aligned within the adjustable reflector.

20. The automated luminaire of claim 19 wherein:
set screws allow for mechanical alignment of the light source.
